(19) United States
(12) Patent Application Publication
(10) Pub. No.: US 2024/0255400 A1
(43) Pub. Date: Aug. 1, 2024

(54) PRESSURE VESSEL OPENING REINFORCEMENT METHOD AND SYSTEM, ELECTRONIC DEVICE AND STORAGE MEDIUM

(71) Applicant: China Special Equipment Inspection & Research Institute, Beijing (CN)

(72) Inventor: Guodong ZHU, Beijing (CN)

(21) Appl. No.: 18/426,407

(22) Filed: Jan. 30, 2024

(30) Foreign Application Priority Data
Jan. 30, 2023 (CN) 202310093788.4

(51) Int. Cl. G01N 3/24; F17C 1/02

(52) U.S. Cl. CPC G01N 3/24; F17C 1/02; F17C 2260/017

(57) ABSTRACT

A pressure vessel opening reinforcement method includes: acquiring cylinder information and nozzle information of pressure vessel; determining axial stress and circumferential stress of cylinder according to the cylinder information; determining ratio of the circumferential stress to the axial stress; determining whether the cylinder meets correction condition, and if so, correcting the stress at different ratios according to the nozzle information, 0-degree section stress concentration coefficient and 90-degree section stress concentration coefficient; otherwise, correcting the stress at different ratios according to stress concentration coefficient when the ratio is first preset ratio threshold and stress concentration coefficient when the ratio is second preset ratio threshold. Problems of unreasonable opening reinforcement calculation and design risk are solved for fixed tubesheet heat exchanger, tower and earth-covered or mounted steel storage vessel cylinder under the action of bending moment and axial force.

### CROSS-REFERENCE TO RELATED APPLICATION

This patent application claims the benefit and priority of Chinese Patent Application No. 202310093788.4 filed with the China National Intellectual Property Administration on Jan. 30, 2023, the disclosure of which is incorporated by reference herein in its entirety as part of the present application.

### TECHNICAL FIELD

The present disclosure relates to the field of pressure vessel opening reinforcement, in particular to a pressure vessel opening reinforcement method and system, an electronic device and a storage medium.

### BACKGROUND

As a pressure-bearing device, a pressure vessel is one of eight categories of special equipment in the Law on Special Equipment Safety, the safety, quality reliability and economy of which are core contents of their construction and operation.

In order to meet the requirements of process operation, vessel inspection and maintenance, it is inevitable to make opening at the cylinder of a pressure vessel. The opening of the vessel weakens the original strength of the cylinder. Therefore, there are a large number of opening reinforcement structures at the pressure vessel. The stress concentration due to discontinuous structure at the opening often becomes a primary reason of the failure and accident of the pressure vessels. Therefore, the opening reinforcement has always been the key content of the safety design of the pressure vessel. Corresponding standard calculation methods should be used for different loads. The commonly used method includes an equal area method, a pressure area method, a membrane-bending method, an analysis method, etc, each of which provides its own application range based on their principles. In order to meet the large-size and complex-load construction requirement, scholars and engineers from all over the world keep to study the opening reinforcement design methods, and some achievements were adopted in the engineering standards of various countries.

### (I) Existing Technology

Current engineering methods include an equal area method, a GB/T 150 analysis method and a TD001 analysis method in China, and abroad engineering methods include an equal area method, German AD pressure area method, European EN pressure area method, ASME membrane-bending method, Appendix 1-10 method, WRC107, WRC297 and so on. All methods have a scope on opening rate, and the opening rate ρ refers to a ratio of the middle diameters of the branch nozzle to the midplane diameter of the cylinder.

The equal area method is the earliest applied method, but the application scope of its opening rate is small (the equal area method requires ρ≤0.3), the range of opening rate of the German AD pressure area method is ρ≤0.7, and the range of opening rate of the EN pressure area method is ρ≤1.0. Because the above mentioned methods cannot be suitable for the opening with the external loads at the end of nozzle, in recent years, WRC107, WRC297 and TD001 analysis methods have been developed successively to solve the design and calculation problem of the opening with external loads at the end of the opening nozzle.

Obviously, although the above methods essentially solve the opening reinforcement of the cylinder under the internal pressure load and the external load at the end of the nozzle, the above methods do not consider the influence of the ratio η of the axial stress to the circumferential stress of the cylinder on the opening reinforcement calculation. As shown in FIG. 1, all the above methods are based on the fact that the axial membrane stress and the circumferential membrane stress meet the relationship of η=σₓ/σ_{θ}=0.5 under the internal pressure of the cylinder. In fact, η does not always meet the relationship of 0.5 in design of a pressure vessel. Common problems are as follows.
(1) Under the action of the wind and earthquake bending moment of a tower, the ratio η of the axial stress to the circumferential stress at an opening position of the cylinder prior to opening is probably greater than 0.5 or less than 0.5.
(2) Under the uneven foundation settlement of the earth-covered vessel, a bending moment appears in the middle section of the cylinder, and the ratio η of the axial stress to the circumferential stress at the opening of the cylinder prior to opening is even negative under the bending moment of the cylinder.
(3) A shell-side cylinder of a heat exchanger generates an axial force under the action of a tube bundle, and the ratio of the axial stress to the circumferential stress at the opening of the cylinder cannot meet η=0.5.

Under the action of a bending moment or an axial force of the cylinder, the proportional relationship η between the axial stress and the circumferential stress at the opening of the cylinder is essentially changed. It is found that different n values influence the stress concentration at the opening, which will lead to the inapplicability of the existing opening reinforcement method.

However, when the stress ratio of the pressure vessel cylinder does not meet η=0.5 in engineering design, there is no standard base and design method yet, and no design calculation method has been found in domestic and abroad reports.

### (II) Problems in the Existing Methods

In the design of pressure vessels, with regards to opening problems, in addition to compensating for the bearing capacity resulted from opening weakening in strength, more attention should be paid to the stress concentration level at the opening edge. The stress concentration becomes more complicated with increased opening rate. The so-called stress concentration means that the stress σₘₐₓ at the structural mutation is much higher than the stress σ at the uniform portion of the cylinder structure. The mechanical characteristics of stress concentration are measured by a stress concentration coefficient, as shown in Formula (1).

$${K}_{t} = \frac{{σ}_{max}}{σ} \qquad ( 1 )$$

Both the equal area method and the pressure area method are calculation methods taking the balance between the bearing capacity of a cylinder section and the pressure load as a criterion based on a primary general average (membrane) stress of a thin shell and the static strength, ignoring the spatial structure and stress concentration.

In Chinese code GB/T 150.3, the analysis method is added for the opening reinforcement under the internal pressure, which is used to solve the opening reinforcement design with a large opening rate and improve calculation accuracy. Therefore, the opening rate is increased to 0.9. The stress analysis method is based on elastic calculation combined with plastic limit design criteria, which fully embodies the essence of stress concentration by ensuring sufficient plastic bearing capacity during primary loading and stability for repeated loading, and considering both primary and secondary stresses to ensure safety of openings.

In order to solve the problem of calculation of large opening reinforcement under the internal pressure, ASME VIII-1 further provides Appendix 1-7 membrane-bending method (with the opening rate not exceeding 0.7) and another method of Appendix 1-10. In Edition 2017 of ASME VIII-1, the Appendix 1-10 method is integrated into chapter 4.5.5 of ASME VIII-2, requiring Di/δs≤400. After example calculation, the two methods provided in the ASME standard have a large deviation, and the maximum deviation exceeds 80%. The two methods are also based on Material Mechanical calculation of the pressure and bending moment, and do not reflect the essence of stress concentration at the opening.

In engineering design, the nozzle often bears the external load from the pipeline, and the resulted stresses at the opening are more complicated. Designers usually use the methods of WRC Bulletin No. 107 and No. 297 issued by American Pressure Vessel Research Council (PVRC) in 1965 and 1984, respectively. This method is only suitable for the case of a small opening rate due to the basis of the approximate thin shell theoretical solution, and is limited in its applicability under the case of a large opening rate.

In order to solve the problem of opening reinforcement of the end of the nozzle with an external load more completely, based on the GB150.3 analysis method, CSCBPV-TD001 provides a strength evaluation method of four positions at the root of the nozzle during opening reinforcement after six force elements at the end of the nozzle are combined with the internal pressure load p_{c}, and the opening rate is extended to 0.9. The purpose of this method is to give the stress concentration coefficients of four positions at the root of the nozzle under seven loads. However, similar to the equal area method and the pressure area method, the influence of the stress ratio η of the stress in the circumferential direction to that the radial direction of the cylinder on the opening reinforcement calculation is ignored.

It can be seen that all methods are based on assumptions that the ratio of the axial membrane stress to the circumferential membrane stress of the cylinder meets the relationship of 1:2 under the internal pressure of the cylinder, which cannot solve the situation that η≠0.5 exists in the cylinder of the pressure vessel in engineering design.

### (III) Intended Technical Level to be Achieved

Under the action of the wind and earthquake bending moment of the tower, the bending moment appears in the middle portion of the cylinder under the uneven foundation settlement of the earth-covered or mounted vessel. A shell-side cylinder of a heat exchanger generates an axial force under the action of a tube bundle. The axial stress at the opening of the cylinder often plays a non-negligible role. Under the action of a bending moment or an axial force of the cylinder, the proportional relationship η between the axial stress and the circumferential stress at the opening of the cylinder is essentially changed.

At present, in domestic and abroad standards, the opening reinforcement calculation method is based on an only internal pressure condition, but in fact, the stress ratio η of the cylinder will vary under the action of the bending moment or the axial force, which is different from the stress concentration under the internal pressure. If the existing method is not modified, it will bring safety risk and unreasonable design.

### SUMMARY

The present disclosure aims to provide a pressure vessel opening reinforcement method and system, an electronic device and a storage medium, which can solve the problem that the opening reinforcement calculation method of a fixed tubesheet heat exchanger, a tower and an earth-covered or mounted steel storage vessel cylinder is missing under the action of a bending moment and an axial force besides the internal pressure, and avoid the problems of current unreasonable design or safety evaluation and design risk.

In order to achieve the above objective, the present disclosure provides the following scheme.

A pressure vessel opening reinforcement method is provided, including:
acquiring cylinder information and nozzle information of a pressure vessel, wherein the cylinder information includes a midplane radius of the cylinder, an effective wall thickness of the cylinder, an axial force of the cylinder and/or a bending moment of the cylinder; and the nozzle information includes a midplane radius of a nozzle and an effective wall thickness of the nozzle;
determining an axial stress and a circumferential stress of the cylinder according to the cylinder information;
determining a ratio of the axial stress to the circumferential stress according to the axial stress and the circumferential stress;
determining whether the cylinder meets a correction condition to obtain a determination result; wherein the correction condition is that the ratio is less than a first preset ratio threshold and an opening rate does not exceed a preset opening rate threshold;
correcting a stress at different ratios according to the nozzle information, a 0-degree section stress concentration coefficient and a 90-degree section stress concentration coefficient, when the determination result is yes; and
correcting the stress at different ratios according to a stress concentration coefficient when the ratio is the first preset ratio threshold and a stress concentration coefficient when the ratio is a second preset ratio threshold, when the determination result is no.

Preferably, determining the axial stress and the circumferential stress of the cylinder according to the cylinder information specifically includes:
determining the axial stress at an opening position of the cylinder prior to opening according to the axial force of the cylinder or the bending moment of the cylinder;
determining the circumferential stress according to the midplane radius of the cylinder and the effective wall thickness of the cylinder.

Preferably, an expression of correcting the stress at different ratios according to the nozzle information, the 0-degree section stress concentration coefficient and the 90-degree section stress concentration coefficient is as follows:

$${σ}_{θ}^{0 °} ( η ) = {σ}_{θ m} \cdot {K}_{t}^{η = 0.5} \cdot [ 1 + ( \frac{{K}_{t}^{η = 0.5} - {K}_{t}^{η = 2.}}{1.5} ) ( 0.5 - η ) ] , η < 0.5$$

where σ_{θ}^{0°}(η) is a corrected stress under the ratio η, σ_{θm} is an overall membrane stress at an inner edge of the opening when the ratio η is 0.5, Kₜ^{η=0.5}=0.5 is the 0-degree section stress concentration coefficient of the opening under an internal pressure p, and Kₜ^{η=2.0} is the 90-degree section stress concentration coefficient.

Preferably, an expression of correcting the stress at different ratios according to the stress concentration coefficient when the ratio is the first preset ratio threshold and the stress concentration coefficient when the ratio is the second preset ratio threshold is as follows:

$${σ}_{θ}^{0 °} ( η ) = ( {σ}_{θ m} \cdot {K}_{t\_ 2}^{η = 0.5} ) \cdot [ 1 + ( \frac{{K}_{t\_ 2}^{η = - 1.} - {K}_{t\_ 2}^{η = 0.5}}{1.5} ) ( 0.5 - η ) ] , η < 0.5$$

where K_{t_2}^{η=0.5} is a stress concentration coefficient when the ratio is 0.5, and K_{t_2}^{η=1.0} is a stress concentration coefficient when the ratio is −1.0.

The present disclosure further provides a pressure vessel opening reinforcement system, including:
an acquiring module, configured to acquire cylinder information and nozzle information of a pressure vessel, wherein the cylinder information includes a midplane radius of a cylinder, an effective wall thickness of the cylinder, an axial force of the cylinder and a bending moment of the cylinder; and the nozzle information includes a midplane radius of a nozzle and an effective wall thickness of the nozzle;
an axial stress and circumferential stress determining module, configured to determine an axial stress and a circumferential stress of the cylinder according to the cylinder information;
a ratio determining module, configured to determine a ratio of the axial stress to the circumferential stress according to the axial stress and the circumferential stress;
a determination module, configured to determine whether the cylinder meets a correction condition to obtain a determination result; wherein the correction condition is that the ratio is less than a first preset ratio threshold and an opening rate does not exceed a preset opening rate threshold;
a first correcting module, configured to, when the determination result is yes, correct a stress at different ratios according to the nozzle information, a 0-degree section stress concentration coefficient and a 90-degree section stress concentration coefficient; and
a second correcting module, configured to, when the determination result is no, correct the stress at different ratios according to a stress concentration coefficient when the ratio is the first preset ratio threshold and a stress concentration coefficient when the ratio is a second preset ratio threshold.

Preferably, the axial stress and circumferential stress determining module specifically includes:
an axial stress determining unit, configured to determine the axial stress at an opening position of the cylinder prior to opening according to the axial force of the cylinder or the bending moment of the cylinder;
a circumferential stress determining unit, configured to determine the circumferential stress according to the midplane radius of the cylinder and the effective wall thickness of the cylinder.

The present disclosure further provides an electronic device, including:
one or more processors;
a storage device on which one or more programs are stored;
wherein the one or more programs, when executed by the one or more processors, cause the one or more processors to implement the method as described above.

The present disclosure further provides a storage medium storing a computer program, wherein the computer program, when executed by a processor, implements the method as described above.

According to the specific embodiments provided by the present disclosure, the present disclosure discloses the following technical effects.

The method includes the following steps: determining the axial stress and circumferential stress of the cylinder according to the cylinder information; determining a ratio of the circumferential stress to the axial stress according to the axial stress and the circumferential stress; determining whether the cylinder meets a correction condition, and if so, correcting the stress at different ratios according to a 0-degree section stress concentration coefficient and a 90-degree section stress concentration coefficient of the opening nozzle; and if not, correcting the stress at different ratios according to a stress concentration coefficient when the ratio is the first preset ratio threshold and a stress concentration coefficient when the ratio is the second preset ratio threshold. Different methods are used to correct the stress at different ratios and opening rates, so as to solve the problems of unreasonable opening reinforcement calculation and design risk of a fixed tubesheet heat exchanger, a tower and an earth-covered or mounted steel storage vessel cylinder under the action of a bending moment and an axial force.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without inventive labor.

FIG. 1 is a schematic diagram of a three-dimensional model of an opening nozzle at a cylinder.

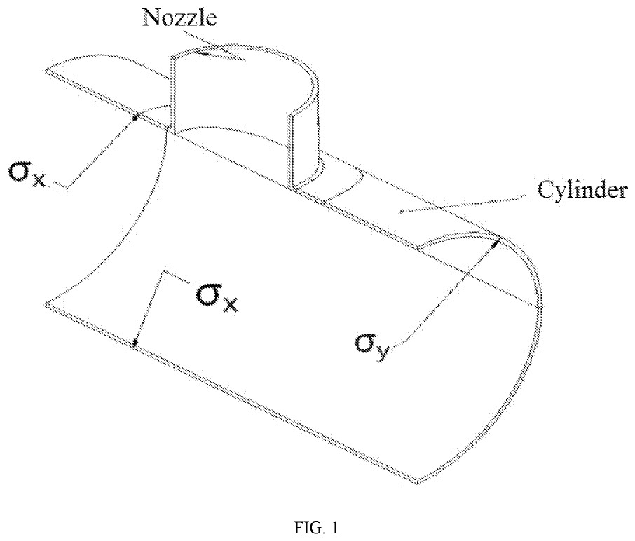

FIG. 2 is an expanded diagram of opening reinforcement.

FIG. 3 is a good linear relationship diagram between a stress concentration coefficient Kₜ and η.

FIG. 4 is a flow chart of a pressure vessel opening reinforcement method according to the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without inventive labor fall within the protection scope of the present disclosure.

The present disclosure aims to provide a pressure vessel opening reinforcement method and system, an electronic device and a storage medium, which can solve unreasonable opening reinforcement calculation and design risk of a fixed tubesheet heat exchanger, a tower and an earth-covered or mounted steel storage vessel cylinder under the action of a bending moment and an axial force.

In order to make the above objects, features and advantages of the present disclosure more apparent and understandable, the present disclosure will be explained in further detail with reference to the drawings and detailed description hereinafter.

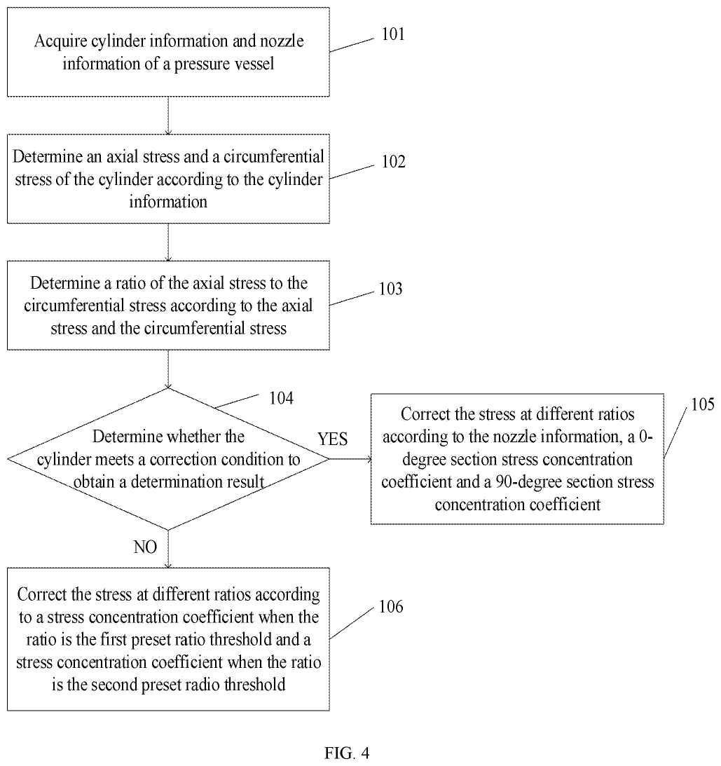

An object of the present disclosure is to provide an opening reinforcement method of a cylinder under the action of an internal pressure and a bending moment or an axial force, so as to achieve the purpose of correcting the opening calculation of the cylinder and solve unreasonable opening reinforcement calculation and design risk of the fixed tubesheet heat exchanger, the tower and the earth-covered or mounted steel storage vessel cylinder under the action of the bending moment and axial force. As shown in FIG. 4, a pressure vessel opening reinforcement method according to the present disclosure includes the following steps 101-106.

Step 101: cylinder information and nozzle information of a pressure vessel are acquired, wherein the cylinder information includes a midplane radius of the cylinder, an effective wall thickness of the cylinder, an axial force of the cylinder and a bending moment of the cylinder; and the nozzle information includes a midplane radius of the nozzle and an effective wall thickness of the nozzle.

Step 102: an axial stress and a circumferential stress of the cylinder are determined according to the cylinder information. The axial stress and the circumferential stress refer to the axial stress and the circumferential stress of an intended opening.

Step 102 specifically includes the following steps.

The circumferential stress is determined according to the midplane radius of the cylinder and the effective wall thickness of the cylinder. First, the circumferential stress of the cylinder is calculated according to an internal pressure p_{c}, as shown in Formula (2). The circumferential stress of the cylinder σ_{θ} is:

$${σ}_{θ} = \frac{{p}_{c} \cdot {R}_{m}}{{δ}_{e}} \qquad ( 2 )$$

where p_{c} is the internal pressure of the cylinder, MPa; Rₘ is the midplane radius of the cylinder, mm; and δₑ is the effective wall thickness of the cylinder, mm.

The axial stress is determined according to the axial force of the cylinder or the bending moment of the cylinder. The axial stress σₓ at an opening is calculated according to the axial force F or the bending moment M of the cylinder.
(a) If the cylinder is subjected to the axial force, the axial stress σ_{x_F} at the opening is calculated according to Formula (3).

$${σ}_{x\_F} = \frac{F}{2 π {R}_{m} \cdot {δ}_{e}} \qquad ( 3 )$$

where F is the axial force of the cylinder, N, which can be obtained by the design and calculation of a device.
(b) If the cylinder is subjected to the bending moment M, the axial stress σ_{x_M} at the opening is calculated according to Formula (4).

$${σ}_{x\_M} = \frac{M}{{W}_{z}} = \frac{32 M}{π {D}_{o}^{3} ( 1 - {α}^{4} )} \qquad ( 4 )$$

where M is the bending moment on the cross section of the cylinder at the center of the opening, which can be obtained according to the design and calculation standard of a device. W_{Z} is a bending section modulus of the cylinder, mm³; Dᵢ is an inner diameter of the cylinder, mm; Dₒ is an outer diameter of the cylinder, mm; and

$$α = \frac{{D}_{i}}{{D}_{o}}$$

is a coefficient, dimensionless.
(c) A total axial stress σₓ at the opening of the cylinder is calculated according to Formula (5).

$${σ}_{x} = {σ}_{x\_F} \pm {σ}_{x\_M} \qquad ( 5 )$$

Step 103: a ratio of the axial stress to the circumferential stress is determined according to the axial stress and the circumferential stress.

The ratio η of the axial stress to the circumferential stress of the cylinder is calculated according to Formula (6).

$$η = \frac{{σ}_{x}}{{σ}_{θ}} \qquad ( 6 )$$

Step 104: it is determined whether the cylinder meets a correction condition to obtain a determination result; wherein the correction condition is that the ratio is less than a first preset ratio threshold and an opening rate does not exceed a preset opening rate threshold. If the determination result is yes, Step 105 is executed. If the determination result is no, Step 106 is executed. The first preset ratio threshold is 0.5, and the preset opening rate threshold is 0.2.

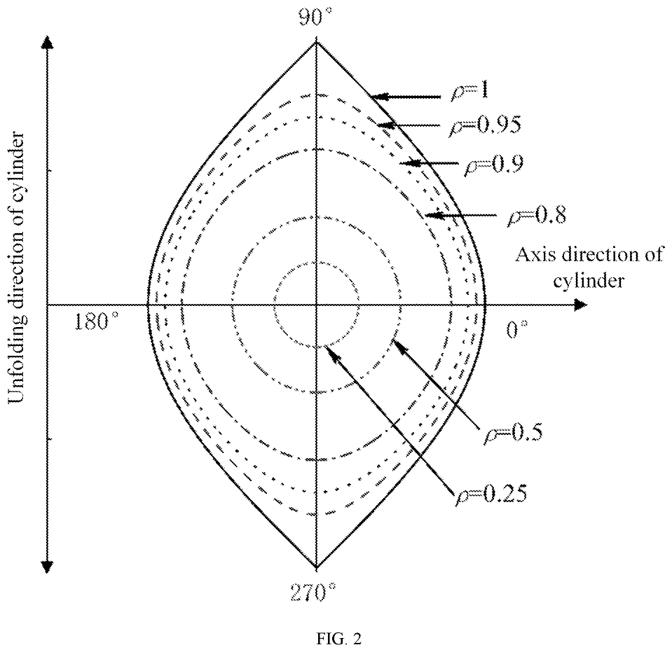

Step 105: a stress at different ratios is corrected according to the nozzle information, a 0-degree section stress concentration coefficient and a 90-degree section stress concentration coefficient. The expression of correcting the stress at different ratios according to the nozzle information, the 0-degree section stress concentration coefficient and the 90-degree section stress concentration coefficient is as follows:

$${σ}_{θ}^{0 °} ( η ) = {σ}_{θ m} \cdot {K}_{t}^{η = 0.5} \cdot [ 1 + ( \frac{{K}_{t}^{η = 0.5} - {K}_{t}^{η = 2.}}{1.5} ) ( 0.5 - η ) ] , η < 0.5 \qquad ( 7 )$$

where σ_{θ}^{0°}(η) is the stress under the ratio η, σ_{θm} is an overall membrane stress at an inner edge of the opening when the ratio is 0.5, Kₜ^{η=0.5} is the 0-degree section stress concentration coefficient, and Kₜ^{η=2.0} is the 90-degree section stress concentration coefficient. When the stress ratio η as per stresses in two directions of the cylinder is less than 0.5 and ρ≤0.2, the stress σ_{θ}^{0°} at the 0-degree section (as shown in FIG. 2) of the opening reinforcement of the cylinder increases, which is corrected according to Formula (7). Kₜ^{η=0.5} and Kₜ^{η=2.0} are obtained after calculation and table lookup under the internal pressure p_{c} according to CSCBPV-TD001. In the evaluation, the concentration coefficients of the primary membrane stress and the primary plus secondary stress should be evaluated, respectively. For the safety evaluation of stress concentration of the primary membrane stress, Kₜ^{η=0.5} and Kₜ^{η=2.0} take the stress concentration coefficient Km of the 0-degree section and that of the 90-degree section in CSCBPV-TD001, respectively. For the safety evaluation of the primary plus secondary stress concentration, Kₜ^{η=0.5} and Kₜ^{η=2.0} are equal to the stress concentration coefficient K of the 0-degree section and that of the 90-degree section in CSCBPV-TD001, respectively.

After calculating the stress σ_{θ}^{0°}(η) under different η values, the safety evaluation is carried out again according to the evaluation criteria in CSCBPV-TD001.

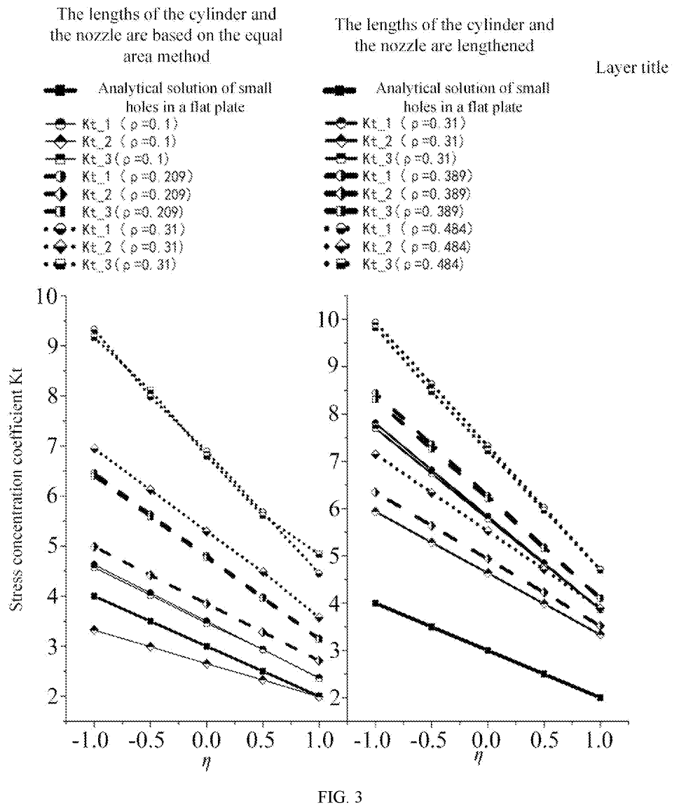

Step 106: the stress at different ratios is corrected according to a stress concentration coefficient when the ratio is the first preset ratio threshold and a stress concentration coefficient when the ratio is a second preset ratio threshold. For the case beyond the correction condition, according to the research, it is found that the concentration coefficient Kₜ has a good linear relationship with η, as shown in FIG. 3. The opening rate on the left side of the layer title in FIG. 3 ranges from 0.1 to 0.31; the opening rate on the right side ranges from 0.31 to 0.484, which are the parameters in the upper right corner of both sides of FIG. 3. The stress σ_{θ}^{0°}(η) at different ratios η can be calculated by Formula (8) according to η. The second preset ratio threshold is 1.0.

The expression of correcting the stress at different ratios according to the stress concentration coefficient when the ratio is the first preset ratio threshold and the stress concentration coefficient when the ratio is the second preset ratio threshold is as follows:

$${σ}_{θ}^{0 °} ( η ) = ( {σ}_{θ m} \cdot {K}_{t\_ 2}^{η = 0.5} ) \cdot [ 1 + ( \frac{{K}_{t\_ 2}^{η = - 1.} - {K}_{t\_ 2}^{η = 0.5}}{1.5} ) ( 0.5 - η ) ] , η < 0.5 \qquad ( 8 )$$

where K_{t_2}^{η=0.5} is a stress concentration coefficient when the ratio is 0.5, and K_{t_2}^{η=1.0} is a stress concentration coefficient when the ratio is −1.0. K_{t_2}^{η=0.5} is the stress concentration coefficient when η=0.5, which is a fixed value when the opening with a certain structure is reinforced and can be obtained by numerical simulation. K_{t_2}^{η=1.0} is the stress concentration coefficient when η=−1.0, which is a fixed value when the opening with a certain structure is reinforced and can be obtained by numerical simulation. After K_{t_2}^{η=0.5} and K_{t_2}^{η=1.0} are obtained by numerical simulation, the stress value of the reinforced structure at any η value can be obtained according to Formula (1). σ_{θm} is the overall membrane stress at the inner edge of the opening when η=0.5, which is calculated according to Formula (2).

According to the corrected stress values under different η values, the safety evaluation of opening reinforcement can be carried out according to standard TD001.

According to the present disclosure, the linear law between the stress concentration coefficient of the nozzle opening at cylinder and η is found based on the law research. The opening reinforcement calculation method under different η values is proposed based on the linear law, so that the stresses under all η values can be obtained by numerical simulation or actual measurement of the stress concentration coefficients under two η values, and the current engineering calculation difficulty is solved. The present disclosure provides a simple engineering correction method. In order to ensure the accuracy of the method, the opening rate is limited to ρ≤0.2.

The current standard CSCBPV-TD001 applies to η=0.5. However, through the method of the present disclosure, the calculation problem under different η values can be solved by using the data in TD001. Specifically:

Based on TD001, the stress concentration coefficients K and Km of the 0-degree section and the 90-degree section can be obtained, which correspond to Kₜ^{η=0.5} and Kₜ^{η=2.0}, respectively. Then, the opening reinforcement stress under different η values can be obtained according to Formula (3), and then is re-evaluated according to the evaluation criteria of TD001.

The present disclosure can carry out opening reinforcement calculation of the cylinder under the action of the internal pressure, the axial force and the bending moment by means of the current standard TD001.

The method of the present disclosure proposes that the stress concentration coefficient has a linear relationship with η, and the opening reinforcement calculation of a given structure under different η can be obtained by means of numerical simulation and testing.

According to the method of the present disclosure, an instance comparison is made on the errors of Formula (7). The parameters of instances are shown in Table 1, and the comparison results are shown in Table 2. The results show that within the range of ρ≤0.2, the result error between ρ≤0.1 and the finite element is controlled to be 28.41%. With the increase of the opening rate p, the error increases gradually, which will bring more conservative results in design. Therefore, the present disclosure limit the application range of the Formula (7) within ρ≤0.2.

For Formula (8), it can be seen from FIG. 3 that the stress concentration coefficient Kₜ−η presents a good linear relationship. According to the linear relationship, the Kₜ values of all η points can be obtained by calculating the Kₜ values of two η points. According to the linearization method, the opening reinforcement correction coefficients of all sizes can be obtained, which facilitates design correction and standard correction.

TABLE 1
parameters of instances table

| Calculating example | A | B |
|---|---|---|
| p_{c}, MPa | 1.0 | 1.6 |
| Dᵢ, mm | 1000 | 1000 |
| δₑ, mm | 8.0 | 8.0 |
| dₒ, mm | 114.3 | 219.1 |
| δₑₜ, mm | 6.3 | 8 |
| ρ, dimensionless | 0.1 | 0.209 |
| E, MPa | 201000 | 201000 |
| [σ]ₛ^{t}\[σ]ₜ^{t}, MPa | 189\181 | 189\181 |

TABLE 2
comparison error table between calculation result and finite
element according to method 1 when η is different

| | membrane stress (S_{II}) | | | | membrane stress + bending stress (S_{IV}) | | | |
|---|---|---|---|---|---|---|---|---|
| | | | finite | | | | finite | |
| Calculating | Kₜ_{_{—}}_{S}_{_{II}}^{η=0.5} | TD001 | element | Error | Kₜ_{_{—}}_{S}_{_{IV}}^{η=0.5} | TD001 | element | Error |
| example | Kₜ_{_{—}}_{S}_{_{II}}^{η=2.0} | correction | (B-B′) | R, % | Kₜ_{_{—}}_{S}_{_{IV}}^{η=2.0} | correction | (B-B′) | R, % |
| A2(η = 0.5) | 2.07 | 130.41 | 135.40 | −3.69% | 2.24 | 141.00 | 140.70 | 0.21% |
| A3(η = 0.0) | 1.36 | 161.19 | 143.90 | 12.02% | 1.67 | 167.71 | 162.40 | 3.27% |
| A4(η = −0.5) | | 191.97 | 180.50 | 6.36% | | 194.42 | 202.50 | −3.99% |
| A5(η = −1.0) | | 222.75 | 168.30 | 32.35% | | 221.12 | 172.20 | 28.41% |
| B2(η = 0.5) | 2.64 | 266.00 | 295.00 | −9.83% | 3.13 | 316.00 | 295.40 | 6.97% |
| B3(η = 0.0) | 1.38 | 377.36 | 331.50 | 13.83% | 1.7 | 466.89 | 349.60 | 33.55% |
| B4(η = −0.5) | | 488.72 | 367.90 | 32.84% | | 617.79 | 404.80 | 52.62% |
| B5(η = −1.0) | | 600.08 | 404.30 | 48.43% | | 768.68 | 459.80 | 67.18% |

The present disclosure further provides a pressure vessel opening reinforcement system, including:
an acquiring module, configured to acquire cylinder information and nozzle information of a pressure vessel, wherein the cylinder information includes a midplane radius of a cylinder, an effective wall thickness of the cylinder, an axial force of the cylinder and a bending moment of the cylinder; and the nozzle information includes a midplane radius of a nozzle and an effective wall thickness of the nozzle;
an axial stress and circumferential stress determining module, configured to determine an axial stress and a circumferential stress of the cylinder according to the cylinder information;
a ratio determining module, configured to determine a ratio of the axial stress to the circumferential stress according to the axial stress and the circumferential stress;
a determination module, configured to determine whether the cylinder meets a correction condition to obtain a determination result; wherein the correction condition is that the ratio is less than a first preset ratio threshold and an opening rate does not exceed a preset opening rate threshold;
a first correcting module, configured to, if the determination result is yes, correct a stress at different ratios according to the nozzle information, a 0-degree section stress concentration coefficient and a 90-degree section stress concentration coefficient; and
a second correcting module, configured to, if the determination result is no, correct the stress at different ratios according to a stress concentration coefficient when the ratio is the first preset ratio threshold and a stress concentration coefficient when the ratio is a second preset ratio threshold.

In an optional embodiment, the axial stress and circumferential stress determining module specifically includes:
an axial stress determining unit, configured to determine the axial stress according to the axial force of the cylinder or the bending moment of the cylinder;
a circumferential stress determining unit, configured to determine the circumferential stress according to the midplane radius of the cylinder and the effective wall thickness of the cylinder.

The present disclosure further provides an electronic device, including:
one or more processors;
a storage device on which one or more programs are stored;
wherein the one or more programs, when executed by the one or more processors, cause the one or more processors to implement the method as described above.

The present disclosure further provides a storage medium storing a computer program, wherein the computer program, when executed by a processor, implements the method as described above.

The present disclosure mainly solves the blank of the design method when the axial membrane stress and the circumferential membrane stress do not meet the relationship of σₓ:σ_{θ}=0.5 under the internal pressure of the cylinder, and solves the unreasonable design and potential safety hazards. At present, other alternatives can be calculated by a finite element method. However, due to the large number of openings in the pressure vessel, the number of nozzles in some towers can exceed 20. If the calculation of the finite element method needs modeling, it is difficult to meet the requirements of efficient design and optimization in engineering due to a high requirement in personnel quality and a long calculation period.

In this specification, various embodiments are described in a progressive way. Each embodiment focuses on the differences from other embodiments, and the same and similar parts of various embodiments can be referred to each other. Since the system disclosed in the embodiment corresponds to the method disclosed in the embodiment, the system is described simply. Relevant parts of the system can refer to the description of the method for the relevant points.

In the present disclosure, specific examples are applied to illustrate the principle and implementation of the present disclosure, and the explanations of the above embodiments are only used to help understand the method and core ideas of the present disclosure. Meanwhile, according to the idea of the present disclosure, there will be some changes in the specific implementation and application scope for those skilled in the art. To sum up, the contents of the specification should not be construed as limiting the present disclosure.

What is claimed is:

1. A pressure vessel opening reinforcement method, comprising:
acquiring cylinder information and nozzle information of a pressure vessel, wherein the cylinder information comprises a midplane radius of a cylinder, an effective wall thickness of the cylinder, an axial force of the cylinder and a bending moment of the cylinder; and the nozzle information comprises a midplane radius of a nozzle and an effective wall thickness of the nozzle;
determining an axial stress and a circumferential stress of the cylinder according to the cylinder information;
determining a ratio of the axial stress to the circumferential stress according to the axial stress and the circumferential stress;
determining whether the cylinder meets a correction condition to obtain a determination result; wherein the correction condition is that the ratio is less than a first preset ratio threshold and an opening rate does not exceed a preset opening rate threshold;
correcting a stress at different ratios according to the nozzle information, a 0-degree section stress concentration coefficient and a 90-degree section stress concentration coefficient, when the determination result is yes; and
correcting the stress at different ratios according to a stress concentration coefficient when the ratio is the first preset ratio threshold and a stress concentration coefficient when the ratio is a second preset ratio threshold, when the determination result is no.

2. The pressure vessel opening reinforcement method according to claim 1, wherein determining the axial stress and the circumferential stress of the cylinder according to the cylinder information comprises:
determining the axial stress at an opening position of the cylinder prior to opening according to the axial force of the cylinder or the bending moment of the cylinder;
determining the circumferential stress according to the midplane radius of the cylinder and the effective wall thickness of the cylinder.

3. The pressure vessel opening reinforcement method according to claim 1, wherein an expression of correcting the stress at different ratios according to the nozzle information, the 0-degree section stress concentration coefficient and the 90-degree section stress concentration coefficient is as follows:
$${σ}_{θ}^{0 °} ( η ) = {σ}_{θ m} \cdot {K}_{t}^{η = 0.5} \cdot [ 1 + ( \frac{{K}_{t}^{η = 0.5} - {K}_{t}^{η = 2.}}{1.5} ) ( 0.5 - η ) ] , η < 0.5$$
where σ_{θ}^{0°}(η) is a corrected stress under the ratio η, σ_{θm} is an overall membrane stress at an inner edge of the opening when the ratio η is 0.5, Kₜ^{η=0.5} is the 0-degree section stress concentration coefficient of the opening under an internal pressure p, and Kₜ^{η=2.0} is the 90-degree section stress concentration coefficient.

4. The pressure vessel opening reinforcement method according to claim 3, wherein an expression of correcting the stress at different ratios according to the stress concentration coefficient when the ratio is the first preset ratio threshold and the stress concentration coefficient when the ratio is the second preset ratio threshold is as follows:
$${σ}_{θ}^{0 °} ( η ) = ( {σ}_{θ m} \cdot {K}_{t\_ 2}^{η = 0.5} ) \cdot [ 1 + ( \frac{{K}_{t\_ 2}^{η = - 1.} - {K}_{t\_ 2}^{η = 0.5}}{1.5} ) ( 0.5 - η ) ] , η < 0.5$$
where K_{t_2}^{η=0.5} is a stress concentration coefficient when the ratio is 0.5, and K_{t_2}^{η=1.0} is a stress concentration coefficient when the ratio is −1.0.

5. A pressure vessel opening reinforcement system, comprising:
an acquiring module, configured to acquire cylinder information and nozzle information of a pressure vessel, wherein the cylinder information comprises a midplane radius of a cylinder, an effective wall thickness of the cylinder, an axial force of the cylinder and a bending moment of the cylinder; and the nozzle information comprises a midplane radius of a nozzle and an effective wall thickness of the nozzle;
an axial stress and circumferential stress determining module, configured to determine an axial stress and a circumferential stress of the cylinder according to the cylinder information;
a ratio determining module, configured to determine a ratio of the axial stress to the circumferential stress according to the axial stress and the circumferential stress;
a determination module, configured to determine whether the cylinder meets a correction condition to obtain a determination result; wherein the correction condition is that the ratio is less than a first preset ratio threshold and an opening rate does not exceed a preset opening rate threshold;
a first correcting module, configured to, when the determination result is yes, correct a stress at different ratios according to the nozzle information, a 0-degree section stress concentration coefficient and a 90-degree section stress concentration coefficient; and
a second correcting module, configured to, when the determination result is no, correct the stress at different ratios according to a stress concentration coefficient when the ratio is the first preset ratio threshold and a stress concentration coefficient when the ratio is a second preset ratio threshold.

6. The pressure vessel opening reinforcement system according to claim 5, wherein the axial stress and circumferential stress determining module comprises:
an axial stress determining unit, configured to determine the axial stress at an opening position of the cylinder prior to opening according to the axial force of the cylinder or the bending moment of the cylinder;
a circumferential stress determining unit, configured to determine the circumferential stress according to the midplane radius of the cylinder and the effective wall thickness of the cylinder.

7. An electronic device, comprising:
one or more processors;
a storage device on which one or more programs are stored;
wherein the one or more programs, when executed by the one or more processors, cause the one or more processors to perform operations comprising:
acquiring cylinder information and nozzle information of a pressure vessel, wherein the cylinder information comprises a midplane radius of a cylinder, an effective wall thickness of the cylinder, an axial force of the cylinder and a bending moment of the cylinder; and the nozzle information comprises a midplane radius of a nozzle and an effective wall thickness of the nozzle;
determining an axial stress and a circumferential stress of the cylinder according to the cylinder information;
determining a ratio of the axial stress to the circumferential stress according to the axial stress and the circumferential stress;
determining whether the cylinder meets a correction condition to obtain a determination result; wherein the correction condition is that the ratio is less than a first preset ratio threshold and an opening rate does not exceed a preset opening rate threshold;
correcting a stress at different ratios according to the nozzle information, a 0-degree section stress concentration coefficient and a 90-degree section stress concentration coefficient, when the determination result is yes; and
correcting the stress at different ratios according to a stress concentration coefficient when the ratio is the first preset ratio threshold and a stress concentration coefficient when the ratio is a second preset ratio threshold, when the determination result is no.

8. The electronic device according to claim 7, wherein determining the axial stress and the circumferential stress of the cylinder according to the cylinder information comprises:
determining the axial stress at an opening position of the cylinder prior to opening according to the axial force of the cylinder or the bending moment of the cylinder;
determining the circumferential stress according to the midplane radius of the cylinder and the effective wall thickness of the cylinder.

9. The electronic device according to claim 7, wherein an expression of correcting the stress at different ratios according to the nozzle information, the 0-degree section stress concentration coefficient and the 90-degree section stress concentration coefficient is as follows:
$${σ}_{θ}^{0 °} ( η ) = {σ}_{θ m} \cdot {K}_{t}^{η = 0.5} \cdot [ 1 + ( \frac{{K}_{t}^{η = 0.5} - {K}_{t}^{η = 2.}}{1.5} ) ( 0.5 - η ) ] , η < 0.5$$
where σ_{θ}^{0°}(η) is a corrected stress under the ratio η, σ_{θm} is an overall membrane stress at an inner edge of the opening when the ratio η is 0.5, Kₜ^{η=0.5} is the 0-degree section stress concentration coefficient of the opening under an internal pressure p, and Kₜ^{η=2.0} is the 90-degree section stress concentration coefficient.

10. The electronic device according to claim 9, wherein an expression of correcting the stress at different ratios according to the stress concentration coefficient when the ratio is the first preset ratio threshold and the stress concentration coefficient when the ratio is the second preset ratio threshold is as follows:
$${σ}_{θ}^{0 °} ( η ) = ( {σ}_{θ m} \cdot {K}_{t\_ 2}^{η = 0.5} ) \cdot [ 1 + ( \frac{{K}_{t\_ 2}^{η = - 1.} - {K}_{t\_ 2}^{η = 0.5}}{1.5} ) ( 0.5 - η ) ] , η < 0.5$$
where K_{t_2}^{η=0.5} is a stress concentration coefficient when the ratio is 0.5, and K_{t_2}^{η=1.0} is a stress concentration coefficient when the ratio is −1.0.

11. A storage medium storing a computer program, wherein the computer program, when executed by a processor, implements the method according to claim 1.

12. The storage medium according to claim 11, wherein determining the axial stress and the circumferential stress of the cylinder according to the cylinder information comprises:
determining the axial stress at an opening position of the cylinder prior to opening according to the axial force of the cylinder or the bending moment of the cylinder;
determining the circumferential stress according to the midplane radius of the cylinder and the effective wall thickness of the cylinder.

13. The storage medium according to claim 11, wherein an expression of correcting the stress at different ratios according to the nozzle information, the 0-degree section stress concentration coefficient and the 90-degree section stress concentration coefficient is as follows:
$${σ}_{θ}^{0 °} ( η ) = {σ}_{θ m} \cdot {K}_{t}^{η = 0.5} \cdot [ 1 + ( \frac{{K}_{t}^{η = 0.5} - {K}_{t}^{η = 2.}}{1.5} ) ( 0.5 - η ) ] , η < 0.5$$
where σ_{θ}^{0°}(η) is a corrected stress under the ratio η, σ_{θm} is an overall membrane stress at an inner edge of the opening when the ratio η is 0.5, Kₜ^{η=0.5} is the 0-degree section stress concentration coefficient of the opening under an internal pressure p, and Kₜ^{η=2.0} is the 90-degree section stress concentration coefficient.

14. The storage medium according to claim 13, wherein an expression of correcting the stress at different ratios according to the stress concentration coefficient when the ratio is the first preset ratio threshold and the stress concentration coefficient when the ratio is the second preset ratio threshold is as follows:
$${σ}_{θ}^{0 °} ( η ) = ( {σ}_{θ m} \cdot {K}_{t\_ 2}^{η = 0.5} ) \cdot [ 1 + ( \frac{{K}_{t\_ 2}^{η = - 1.} - {K}_{t\_ 2}^{η = 0.5}}{1.5} ) ( 0.5 - η ) ] , η < 0.5$$
where K_{t_2}^{η=0.5} is a stress concentration coefficient when the ratio is 0.5, and K_{t_2}^{η=1.0} is a stress concentration coefficient when the ratio is −1.0.
